(19) United States
(12) Patent Application Publication
(10) Pub. No.: US 2011/0259801 A1
(43) Pub. Date: Oct. 27, 2011

(54) Shavings Saver Sifter

(76) Inventor: William DeSelle, Hollis, NH (US)

(21) Appl. No.: 12/582,617

(22) Filed: Apr. 23, 2010

(51) Int. Cl. B07B 1/46

(52) U.S. Cl. 209/406

(57) ABSTRACT

A portable shavings sifter that is particularly adapted for separating soiled wood shavings used in animal stalls as bedding materials from manure contained in the bedding material. The wood shavings are recovered for reuse and the manure is separated therefrom for disposal. The shavings sifter is shaped to fit within a muck bucket and embodies two handles which rest on the upper lip of the bucket. The shavings sifter includes a number of longitudinally extending, substantially parallel steel rods that are spaced from each to enable the dry wood shavings to pass therethrough while the manure is maintained within the device.

This application emanates from a previously filed provisional application; Application 61/106,960 filed Oct. 20, 2008.

### FIELD OF THE INVENTION

The present invention relates to separating apparatus for separating wood shavings used as animal stall bedding materials from animal defecation deposited in an on the bedding material. More particularly, the present invention relates to a shaker table apparatus for separating reusable horse stall bedding materials in the form of wood shavings from horse manure, wherein the apparatus is portable and is adapted to be wheeled from horse stall to horse stall and to be used therein.

### BACKGROUND OF THE INVENTION

In animal stalls, such as horse stalls, wood shavings, which have a curled form, are often used as bedding materials that are spread over the floor of the stall. Some of the shavings become soiled by animal urine, and horse manure is deposited on the shavings from time to time.

Urine-soaked wood shavings and manure that is concentrated in particular areas of a horse stall are typically manually removed by use of a pitchfork having closely-spaced tines. Because many horses deposit their droppings in a random manner, and do not repeatedly defecate in a single place within the stall, the separation of the droppings from the wood shavings by the use of a pitchfork becomes a cumbersome and a time-consuming task. As a result, a combination of the droppings and some of the wood shavings is frequently removed from the stalls and discarded. However, the combination contains clean wood shavings that could be reused if they were to be separated from the droppings. Such reuse would result in significant operating cost savings for horse owners, and it would promote environmental preservation by minimizing the waste and unnecessary disposal of natural resources.

Accordingly, there is a need for a more efficient way to separate wood shavings used in horse stalls from the horse manure that exists within the stalls. One possible way to separate such materials is by a suitable screening device that would permit only the wood shavings to pass through the screen and back to the floor of the stall, while the manure is separated and collected for disposal.

Separating and screening devices for separating and classifying particulate materials by size are well known. An example of a common structural configuration for such devices is shown in U.S. Pat. No. 1,773,405, entitled, “Vibrating Screen”, which issued on Aug. 19, 1930 to G. A. Overstrom. That device is in the form of a vibrating screen box that is supported on spiral springs and that is inclined relative to the horizontal. Vibration of the screen is effected by rotating an unbalanced rotor that is mounted to the screen box above and between the longitudinal ends of the screen box to cause the box and screen to vibrate, whereupon the smaller particles pass through the screen while the larger particles remain on the surface of the screen and can be separately removed.

Another form of separator device, one especially adapted for screening wood chips, is disclosed in U.S. Pat. No. 5,305,891, entitled, “Wood Chip Bar Screen Deck Arrangement”, which issued on Apr. 26, 1994, to Joseph B. Bielagus. That device incorporates a plurality of longitudinally extending parallel bars that are mounted in separate, interlaced arrays. The top surfaces of the respective arrays are spaced from each other in two planes, and the arrays are actuated by a drive belt or chain arrangement that causes the bar arrays to move vertically, and relative to each other, to allow wood chips of a predetermined thickness to pass through the arrays while thicker chips are prevented from passing through.

Although vibratory screening devices have been employed for some time, no such devices appear to have been devised that are intended to be used for separating and recovering for reuse highly irregularly shaped materials, such as curled wood shavings of the type that are commonly used as bedding materials in animal stalls, such as horse stalls. In that regard, it is common practice when using a pitchfork to remove an excess of such wood shavings along with the manure. And an attempt to separate the wood shavings from the manure using a pitchfork is a cumbersome and a time-consuming process that is impractical if a significant number of stalls are to be cleaned in that manner because the frequency of defecation by horses requires that horse stalls be cleaned each day.

Generally, because of the difficulty and the time involved, when manure is present in a horse stall a large percentage of clean wood shavings is removed from the stall along with the manure. Those shavings are disposed of along with the manure and are replaced by new wood shavings. However, the disposal of such clean and reusable shavings unnecessarily increases the costs for housing and maintaining animals, and is of particular interest to those who house a number of horses. Consequently, if the manure could be easily separated from the wood shavings a substantial operating cost saving could be experienced over a period of time, particularly where a number of such stalls are involved. The avoidance of the waste of perfectly good and reusable shavings would also be beneficial from an environmental standpoint.

Accordingly, it is an object of the present invention to provide separating apparatus that operates to separate reusable wood shavings from animal manure.

### SUMMARY OF THE INVENTION

I have invented a devise that improves the ability to save money on shavings in horse stalls

### BRIEF DESCRIPTION OF THE DRAWING

FIG. 1 is a perspective view of the top/front of the device

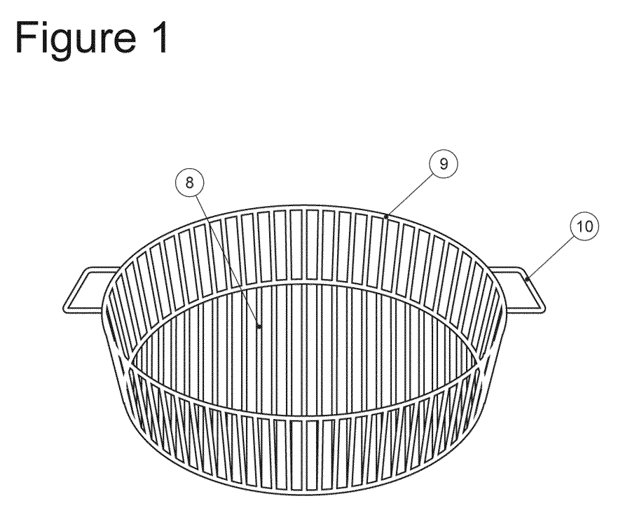

1. A shavings saver sifter for separating manure and shavings comprising an upper and lower structural ring connected by a circular wall of evenly spaced vertical sifting bars;
a screen of sifting bars extending substantially horizontally across the bottom interior of said circular wall;
a D-shaped adapter mounted on the upper, apposing sides of said circular wall.

2. The shavings saver sifter of claim 1, wherein the device fits inside existing muck buckets used to remove manure from horse stalls.

3. The shavings saver sifter of claim 1, wherein the screen is sized to retain animal waste without the destruction of said waste.

4. The shavings saver sifter of claim 1, wherein said circular wall embodies the same spacing of its members as the floor of the device.

5. The shavings saver sifter of claim 1, wherein the device is constructed of metallic or resin based materials.

6. The shavings saver sifter device comprising a bowl shaped sifter with two apposing handles a sifting floor and radial sifting walls by which horse manure can be placed while said sifter can be placed within existing muck buckets.
